(19) United States
(12) Patent Application Publication
(10) Pub. No.: US 2025/0055026 A1
(43) Pub. Date: Feb. 13, 2025

(54) SULFIDE-BASED SOLID ELECTROLYTE DOPED WITH SILVER AND ALL-SOLID-STATE BATTERY INCLUDING THE SAME

(71) Applicant: KOREA ELECTRONICS TECHNOLOGY INSTITUTE, Seongnam-si (KR)

(72) Inventors: Seung Ho CHOI, Seongnam-si (KR); Ji Sang YU, Seongnam-si (KR); Woo Suk CHO, Seongnam-si (KR); Kyung Su KIM, Seongnam-si (KR)

(21) Appl. No.: 18/796,796

(22) Filed: Aug. 7, 2024

(30) Foreign Application Priority Data
Aug. 7, 2023 (KR) 10-2023-0102624

(51) Int. Cl. H01M 10/0562; H01M 4/02; H01M 4/04; H01M 4/134; H01M 4/40

(52) U.S. Cl. CPC H01M 10/0562; H01M 4/0404; H01M 4/0407; H01M 4/134; H01M 4/405; H01M 2004/027; H01M 2300/008

(57) ABSTRACT

Disclosed are a sulfide-based solid electrolyte doped with silver to have a novel composition, and an all-solid-state battery including the same.

According to one aspect of the present disclosure for achieving the above-described technical purpose, there is provided a sulfide-based solid electrolyte comprising a compound represented by a following Chemical formula 1:

Li_{a-b}M_{b}P_{c}S_{d}Xₑ [Chemical formula 1]
wherein M includes at least one selected from the group consisting of Ag, Na, K, Rb, Cs, Fr, and a combination thereof, wherein X includes at least one selected from the group consisting of F, Cl, Br, I, and combinations thereof, wherein 0<a≤15, 0.02≤b≤0.9, 0≤c≤3, 0<d≤12, and 0≤e≤3.

### CROSS-REFERENCE TO RELATED APPLICATION

This application claims priority from Korean Patent Application No. 10-2023-0102624 filed on Aug. 7, 2023 in the Korean Intellectual Property Office, and all the benefits accruing therefrom under 35 U.S.C. 119, the contents of which in its entirety are herein incorporated by reference.

The research project information of the present invention is as follows.
Project unique number: 20007045
Ministry name: Ministry of Trade, Industry and Energy
Research management specialized organization: Korea Institute of Industrial Technology Planning and Evaluation
Research project name: Industrial core technology development project
Research project name: (R) Development of a high-voltage battery system for electric vehicles with an ultra-fast charging function of about 1 minute
Main organization: Korea Electronics Technology Institute
Research period: 2019 Sep. 1-2026 May 31

### BACKGROUND

### Field

The present disclosure relates to a sulfide-based solid electrolyte doped with silver and an all-solid-state battery including the same.

### Description of Related Art

Lithium ion batteries are widely used in various devices requiring energy storage. Depending on the application field thereof, various battery characteristics such as high energy density, long cycle life, fast charge/discharge, and high/low temperature battery operation performance are required.

Recently, the automobile industry, which is a means of transportation, is interested in electric vehicles using secondary batteries as fossil fuels are being avoided to solve environmental problems caused by carbon dioxide (CO₂). The vehicle using a currently developed lithium-ion battery may travel about 400 km per a single charge. However, problems such as instability and fire at high temperatures still exist. To solve these problems, many companies are competitively developing next-generation secondary batteries.

The all-solid-state battery, which is attracting attention as a next-generation secondary battery, has the advantage of having less risk of fire and explosion and higher mechanical strength, compared to the lithium-ion battery that uses flammable organic solvents as electrolytes because all of components thereof are solid. However, a negative-electrode active material layer of the all-solid-state battery is generally made of a mixture of the negative-electrode active material with a solid electrolyte to secure ion conductivity. However, since the solid electrolyte has a larger specific gravity than that of the liquid electrolyte, the conventional all-solid-state battery has a disadvantage of lower energy density than that of the lithium-ion battery.

To solve this problem, research is being conducted on a negative-electrode-free all-solid-state battery which is free of a negative electrode active material from the all-solid-state battery or in which only a small amount of the negative-electrode active material is used, and lithium precipitates in the form of metal on the negative-electrode current collector. However, when lithium ions are not stored in graphite but precipitate on the negative-electrode current collector in the form of lithium metal as described above, there is a problem that irreversible reactions gradually increase due to uneven precipitation of lithium or dendrite formation, and thus, the lifespan and durability of the battery are greatly reduced.

### SUMMARY

A purpose of the present disclosure is to provide a sulfide-based solid electrolyte doped with silver to have a novel composition.

A purpose of the present disclosure is to provide an all-solid-state battery in which lithium is uniformly formed and remigrated and dendrites are not formed even when charge and discharge of the battery are repeated, thereby providing excellent lifespan and durability of the battery.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims or combinations thereof.

According to one aspect of the present disclosure for achieving the above-described technical purpose, there is provided a sulfide-based solid electrolyte comprising a compound represented by a following Chemical formula 1:

Li_{a-b}M_{b}P_{c}S_{d}Xₑ [Chemical formula 1]
wherein M includes at least one selected from the group consisting of Ag, Na, K, Rb, Cs, Fr, and a combination thereof,
wherein X includes at least one selected from the group consisting of F, Cl, Br, I, and combinations thereof,
wherein 0<a≤15, 0.02≤b≤0.9, 0≤c≤3, 0<d≤12, and 0≤e≤3.

In accordance with some embodiments of the sulfide-based solid electrolyte, M is Ag.

In accordance with some embodiments of the sulfide-based solid electrolyte, the sulfide-based solid electrolyte has an argyrodite type crystal structure.

In accordance with some embodiments of the sulfide-based solid electrolyte, a peak appearing at 2θ=29.8°±1.0° of an XRD result of the sulfide-based solid electrolyte shifts to a smaller angle as b increases.

According to another aspect of the present disclosure for achieving the above-described technical purpose, there is provided an all-solid-state battery comprising: a negative-electrode current collector; a negative-electrode active material layer disposed on the negative-electrode current collector; a solid electrolyte layer disposed on the negative-electrode active material layer; a positive-electrode active material layer disposed on the solid electrolyte layer; and a positive-electrode current collector disposed on the positive-electrode active material layer, wherein at least one of the negative-electrode active material layer, the positive-electrode active material layer, and the solid electrolyte layer includes the sulfide-based solid electrolyte as described above.

According to still another aspect of the present disclosure for achieving the above-described technical purpose, there is provided an all-solid-state battery comprising: a negative-electrode current collector; a coating layer disposed on the negative-electrode current collector; a solid electrolyte layer disposed on the coating layer; a positive-electrode active material layer disposed on the solid electrolyte layer; and a positive-electrode current collector disposed on the positive-electrode active material layer, wherein the coating layer comprises a lithium alloy represented by Li-M, wherein M includes at least one selected from the group consisting of Ag, Na, K, Rb, Cs, Fr, and combinations thereof, wherein M in the lithium alloy is derived from the sulfide-based solid electrolyte as described above.

According to still another aspect of the present disclosure for achieving the above-described technical purpose, there is provided a method for preparing a sulfide-based solid electrolyte, the method comprising: preparing a raw material; pulverizing the raw material to obtain an intermediate material; and heat-treating the intermediate material, wherein the sulfide-based solid electrolyte comprises a compound represented by a following Chemical formula 1:

Li_{a-b}M_{b}P_{c}S_{d}Xₑ [Chemical formula 1]
wherein M includes at least one selected from the group consisting of Ag, Na, K, Rb, Cs, Fr, and a combination thereof,
wherein X includes at least one selected from the group consisting of F, Cl, Br, I, and combinations thereof, wherein 0<a≤15, 0.02≤b≤0.9, 0≤c≤3, 0<d≤12, and 0≤e≤3.

In accordance with some embodiments of the method, M is Ag.

In accordance with some embodiments of the method, the sulfide-based solid electrolyte has an argyrodite type crystal structure.

In accordance with some embodiments of the method, a peak appearing at 2θ=29.8°±1.0° of an XRD result of the sulfide-based solid electrolyte shifts to a smaller angle as b increases.

According to the present disclosure, the sulfide-based solid electrolyte doped with silver so as to have the novel composition may be obtained.

According to the present disclosure, there may be provided the all-solid-state battery in which lithium is uniformly formed and removed and dendrites are not formed even when charge and discharge of the battery are repeated, thereby providing excellent lifespan and durability of the battery.

Effects of the present disclosure are not limited to the effects mentioned above, and other effects not mentioned will be clearly understood by those skilled in the art from the description below.

In addition to the above effects, specific effects of the present disclosure are described together while describing specific details for carrying out the present disclosure.

### BRIEF DESCRIPTION OF DRAWINGS

FIG. 1 illustrates a first embodiment of an all-solid-state battery according to the present disclosure.

FIG. 2 illustrates a second embodiment of an all-solid-state battery according to the present disclosure.

FIG. 3 illustrates the all-solid-state battery of FIG. 2 in a charged state.

FIG. 4A is an image of a sulfide-based solid electrolyte according to Present Example 1 as taken by Scanning Electron Microscope (SEM).

FIG. 4B to FIG. 4E are images of the sulfide-based solid electrolyte according to Present Example 1 as taken by Energy Dispersive Spectrometer (EDS).

FIG. 5A is an image of a sulfide-based solid electrolyte according to Present Example 2 as taken by Scanning Electron Microscope (SEM).

FIG. 5B to FIG. 5E are images of the sulfide-based solid electrolyte according to Present Example 2 as taken by Energy Dispersive Spectrometer (EDS).

FIG. 6A is an XRD (X-ray diffraction) analysis result of a sulfide-based solid electrolyte according to each of Present Examples 1 to 7 and Comparative Example 1.

FIG. 6B is an enlarged image of a region around 20=30° of FIG. 6A.

FIG. 7A is an XRD (X-ray diffraction) analysis result of a sulfide-based solid electrolyte according to each of Present Example 8 and Comparative Example 2.

FIG. 7B is an enlarged image of a region around 20=29° of FIG. 7A.

FIG. 8 is a voltage-capacity graph at initial charge-discharge of a half-cell according to a manufacturing example.

FIG. 9 shows a result of measuring a capacity while increasing charge/discharge cycles of a half-cell according to a manufacturing example.

FIG. 10 shows a voltage-capacity graph of a half-cell according to a manufacturing example.

FIG. 11 shows images of states of a half-cell according to a manufacturing example before and after initial charging thereof.

### DETAILED DESCRIPTIONS

Advantages and features of the present disclosure, and a method of achieving the advantages and features will become apparent with reference to embodiments described later in detail together with the accompanying drawings. However, the present disclosure is not limited to the embodiments as disclosed under, but may be implemented in various different forms. Thus, these embodiments are set forth only to make the present disclosure complete, and to completely inform the scope of the present disclosure to those of ordinary skill in the technical field to which the present disclosure belongs, and the present disclosure is only defined by the scope of the claims.

For simplicity and clarity of illustration, elements in the drawings are not necessarily drawn to scale. The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

A shape, a size, a ratio, an angle, a number, etc. disclosed in the drawings for illustrating embodiments of the present disclosure are illustrative, and embodiments of the present disclosure are not limited thereto.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of associated listed items. Expression such as “at least one of” when preceding a list of elements may modify the entire list of elements and may not modify the individual elements of the list. In interpretation of numerical values, an error or tolerance therein may occur even when there is no explicit description thereof.

In addition, it will also be understood that when a first element or layer is referred to as being present “on” a second element or layer, the first element may be disposed directly on the second element or may be disposed indirectly on the second element with a third element or layer being disposed between the first and second elements or layers. It will be understood that when an element or layer is referred to as being “connected to”, or “connected to” another element or layer, it may be directly on, connected to, or connected to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

Further, as used herein, when a layer, film, region, plate, or the like is disposed “on” or “on a top” of another layer, film, region, plate, or the like, the former may directly contact the latter or still another layer, film, region, plate, or the like may be disposed between the former and the latter. As used herein, when a layer, film, region, plate, or the like is directly disposed “on” or “on a top” of another layer, film, region, plate, or the like, the former directly contacts the latter and still another layer, film, region, plate, or the like is not disposed between the former and the latter. Further, as used herein, when a layer, film, region, plate, or the like is disposed “below” or “under” another layer, film, region, plate, or the like, the former may directly contact the latter or still another layer, film, region, plate, or the like may be disposed between the former and the latter. As used herein, when a layer, film, region, plate, or the like is directly disposed “below” or “under” another layer, film, region, plate, or the like, the former directly contacts the latter and still another layer, film, region, plate, or the like is not disposed between the former and the latter.

In descriptions of temporal relationships, for example, temporal precedent relationships between two events such as “after”, “subsequent to”, “before”, etc., another event may occur therebetween unless “directly after”, “directly subsequent” or “directly before” is not indicated.

When a certain embodiment may be implemented differently, a function or an operation specified in a specific block may occur in a different order from an order specified in a flowchart. For example, two blocks in succession may be actually performed substantially concurrently, or the two blocks may be performed in a reverse order depending on a function or operation involved.

It will be understood that, although the terms “first”, “second”, “third”, and so on may be used herein to describe various elements, components, regions, layers and/or periods, these elements, components, regions, layers and/or periods should not be limited by these terms. These terms are used to distinguish one element, component, region, layer or section from another element, component, region, layer or period. Thus, a first element, component, region, layer or section as described under could be termed a second element, component, region, layer or period, without departing from the spirit and scope of the present disclosure.

The features of the various embodiments of the present disclosure may be partially or entirely combined with each other, and may be technically associated with each other or operate with each other. The embodiments may be implemented independently of each other and may be implemented together in an association relationship.

It will be understood that when an element or layer is referred to as being “connected to”, or “connected to” another element or layer, it may be directly on, connected to, or connected to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, “embodiments,” “examples,” “aspects, and the like should not be construed such that any aspect or design as described is superior to or advantageous over other aspects or designs.

Further, the term ‘or’ means ‘inclusive or’ rather than ‘exclusive or’. That is, unless otherwise stated or clear from the context, the expression that ‘x uses a or b’ means any one of natural inclusive permutations.

The terms used in the description below have been selected as being general and universal in the related technical field. However, there may be other terms than the terms depending on the development and/or change of technology, convention, preference of technicians, etc. Therefore, the terms used in the description below should not be understood as limiting technical ideas, but should be understood as examples of the terms for illustrating embodiments.

Unless otherwise specified, all numbers, values, and/or expressions expressing quantities of components, reaction conditions, quantities of polymer compositions, and blends used herein are approximations that reflect, among other things, the various uncertainties of measurement that arise in obtaining such values and the numbers, and therefore should be understood to be modified in all instances by the term “about.” Furthermore, where a numerical range is disclosed herein, the numerical range is continuous and includes all values in a range from the minimum value to the maximum value, including the minimum value and the maximum value, unless otherwise indicated. Furthermore, where the numerical range refers to an integer, all integers in a range from the minimum value to the maximum value, including the minimum value and the maximum value are included in the numerical range, unless otherwise specified.

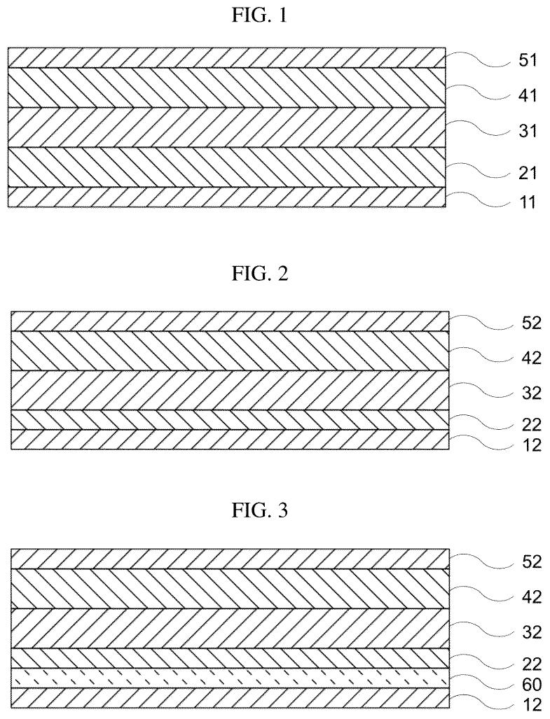

FIG. 1 illustrates a first embodiment of an all-solid-state battery according to the present disclosure.

The all-solid-state battery may include a first negative-electrode current collector 11, a first negative-electrode active material layer 21, a first solid electrolyte layer 31, a first positive-electrode active material layer 41, and a first positive-electrode current collector 51.

At least one of the first negative-electrode active material layer 21, the first solid electrolyte layer 31, and the first positive-electrode active material layer 41 may include a sulfide-based solid electrolyte doped with silver (Ag) according to the present disclosure.

Hereinafter, each of the first negative-electrode current collector 11, the first negative-electrode active material layer 21, the first solid electrolyte layer 31, the first positive-electrode active material layer 41, and the first positive-electrode current collector 51 will be described.

The first negative-electrode current collector 11 may include an electrically conductive plate-shaped substrate. Specifically, the first negative-electrode current collector 11 may have a form of a sheet, a thin film, or a foil.

The first negative-electrode current collector 11 may include a material that does not react with lithium. Specifically, the first negative-electrode current collector 11 may include at least one selected from the group consisting of nickel (Ni), copper (Cu), stainless steel, and combinations thereof.

The first negative-electrode active material layer 21 may include a composite negative-electrode including a negative-electrode active material, a solid electrolyte, etc.

The negative-electrode active material is not particularly limited, and may include at least one selected from the group consisting of a carbon active material, a metal active material, and a combination thereof.

The carbon active material may include mesocarbon microbeads, graphite such as highly oriented graphite, amorphous carbon such as hard carbon, and soft carbon, etc.

The metal active material may include at least one selected from the group consisting of indium (In), aluminum (Al), silicon (Si), tin (Sn), and a combination thereof.

The solid electrolyte may include a sulfide-based solid electrolyte doped with silver (Ag) according to the present disclosure. The sulfide-based solid electrolyte doped with silver (Ag) will be described later.

The solid electrolyte may further include a solid electrolyte having a different composition from that of the sulfide-based solid electrolyte doped with silver (Ag) according to the present disclosure in addition to the sulfide-based solid electrolyte doped with silver (Ag) according to the present disclosure. For example, the first negative-electrode active material layer 21 may further include an oxide-based solid electrolyte or a sulfide-based solid electrolyte.

The sulfide-based solid electrolyte is not particularly limited, but may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (where m and n are positive numbers, and Z is one of Ge, Zn, and Ga), Li₂S—GeS₂, Li₂S—SiS₂—Li₃PO₄, Li₂S—SiS₂-LiₓMO_{y} (where x and y are positive numbers, M is one of P, Si, Ge, B, Al, Ga, and In), and, Li₁₀GeP₂S₁₂.

The oxide-based solid electrolyte may include LiPON (lithium phosphorous oxynitride), garnet-based solid electrolyte, perovskite-based solid electrolyte, NASICON (Na-super ionic conductor)-based solid electrolyte, etc.

The garnet-based solid electrolyte may include Li_{7-y}La₃₋ₓAₓZr_{2-y}M_{y}O₁₂ (wherein 0≤x≤3, and 0≤y≤2, A is at least one selected from the group consisting of Y, Nd, Sm, and Gd, and M is Nb or Ta).

The perovskite-based solid electrolyte may include Li_{0.5-3x}La_{0.5+x}TiO₃ (wherein, x is 0≤x≤0.15).

The NASICON (Na-super ionic conductor)-based solid electrolyte may include Li₁₊ₓAlₓTi₂₋ₓ(PO₄)₃ (where 0≤x≤3), Li₁₊ₓAlₓGe₂₋ₓ(PO₄)₃ (where, 0≤x≤3), etc.

In one example, the first negative-electrode active material layer 21 may include lithium metal or a lithium metal alloy.

The lithium metal alloy may include an alloy of lithium and a metal or metalloid that is able to be alloyed with lithium. The metal or metalloid that is able to be alloyed with lithium may include Si, Sn, Al, Ge, Pb, Bi, Sb, etc.

The first solid electrolyte layer 31 may include a sulfide-based solid electrolyte doped with silver (Ag) according to the present disclosure. The sulfide-based solid electrolyte doped with silver (Ag) will be described later.

The first solid electrolyte layer 31 may further include a solid electrolyte having a different composition from that of the sulfide-based solid electrolyte doped with silver (Ag) according to the present disclosure in addition to the sulfide-based solid electrolyte doped with silver (Ag) according to the present disclosure. For example, the first solid electrolyte layer 31 may further include an oxide-based solid electrolyte or a sulfide-based solid electrolyte.

The oxide-based solid electrolyte and the sulfide-based solid electrolyte are as described above.

The polymer electrolyte may include a gel polymer electrolyte, a solid polymer electrolyte, etc.

The positive-electrode active material layer 41 may include a positive-electrode active material, a solid electrolyte, a conductive material, a binder, etc.

The positive-electrode active material reversibly absorbs and releases lithium ions. The positive-electrode active material may be an oxide active material or a sulfide active material.

The oxide active material may be a rock salt layer-type active material such as LiCoO₂, LiMnO₂, LiNiO₂, LiVO₂, Li₁₊ₓNi_{1/3}Co_{1/3}Mn_{1/3}O₂, a spinel-type active material such as LiMn₂O₄, Li(Ni_{0.5}Mn_{1.5})O₄, a reverse spinel-type active material such as LiNiVO₄, LiCoVO₄, an olivine-type active material such as LiFePO₄, LiMnPO₄, LiCoPO₄, LiNiPO₄, etc., a silicon-containing active material such as Li₂FeSiO₄, Li₂MnSiO₄, etc., a rock salt layer-type active material in which a portion of the transition metal is replaced with a dissimilar metal such as LiNi_{0.8}Co_{(0.2-x)}AlₓO₂(0<x<0.2), a spinel-type active material in which a portion of the transition metal is replaced with a dissimilar metal such as Li₁₊ₓMn_{2-x-y}MyO₄ (M is at least one of Al, Mg, Co, Fe, Ni, and Zn, 0<x+y<2), or lithium titanate such as Li₄Ti₅O₁₂, etc.

The sulfide active material may include copper chevrel, iron sulfide, cobalt sulfide, nickel sulfide, etc.

The first positive-electrode active material layer 41 may include the sulfide-based solid electrolyte doped with silver (Ag) according to the present disclosure. The sulfide-based solid electrolyte doped with silver (Ag) will be described later.

The first positive-electrode active material layer 41 may further include a solid electrolyte having a different composition from that of the sulfide-based solid electrolyte doped with silver (Ag) according to the present disclosure in addition to the sulfide-based solid electrolyte doped with silver (Ag) according to the present disclosure. For example, the first positive-electrode active material layer 41 may further include an oxide-based solid electrolyte or a sulfide-based solid electrolyte. The oxide-based solid electrolyte and the sulfide-based solid electrolyte are as described above.

The conductive material may include carbon black, conductive graphite, ethylene black, graphene, etc.

The binder may include BR (Butadiene rubber), NBR (Nitrile butadiene rubber), HNBR (Hydrogenated nitrile butadiene rubber), PVDF (polyvinylidene difluoride), PTFE (polytetrafluoroethylene), CMC (carboxymethylcellulose), etc.

The first positive-electrode current collector 51 may be a plate-shaped substrate having electrical conductivity. The first positive-electrode current collector 51 may include an aluminum foil. In the first embodiment, when the all-solid-state battery is initially charged at a voltage of 1.8 V to 0 V, the battery may exhibit a flat level characteristic at 0.2 V to 0.05 V in a graph in which an X-axis represents a battery capacity (mAh/cm²) and a Y-axis represents the voltage (V).

FIG. 2 illustrates a second embodiment of an all-solid-state battery according to the present disclosure. The all-solid-state battery may include a second negative-electrode current collector 12, a coating layer 22, a second solid electrolyte layer 32, a second positive-electrode active material layer 42, and a second positive-electrode current collector 52.

The all-solid-state battery of the second embodiment may not include a negative-electrode active material or a component that plays substantially the same role as that of the negative-electrode active material.

FIG. 3 illustrates a charged state of the all-solid-state battery of the second embodiment. When the all-solid-state battery is charged, lithium ions that have migrated from the second positive-electrode active material layer 42 may be precipitated in the form of lithium metal and/or lithium alloy in an area between the coating layer 22 and the second negative-electrode current collector 12. That is, the all-solid-state battery in the charged state may include a lithium metal layer 60 including lithium metal and/or lithium alloy and disposed between the coating layer 22 and the second negative-electrode current collector 12.

Each of the second negative-electrode current collector 12, the second solid electrolyte layer 32, the second positive-electrode active material layer 42, and the second positive-electrode current collector 52 has the same configuration as that of each of the first negative-electrode current collector 11, the first solid electrolyte layer 31, the first positive-electrode active material layer 41, and the first positive-electrode current collector 51 and thus, descriptions thereof will be omitted below.

The above coating layer 22 may include a lithium alloy represented by Li-M (M includes at least one selected from the group consisting of Ag, Na, K, Rb, Cs, Fr, and combinations thereof). M in the lithium alloy may be derived from the sulfide-based solid electrolyte doped with silver (Ag) according to the present disclosure.

The doping element M includes all elements that may exist as a monovalent cation having an ionic radius larger than that of lithium cation (Li⁺) when being in an ionic state, and specifically, may include silver (Ag), sodium (Na), potassium (K), rubidium (Rb), cesium (Cs), francium (Fr), etc. For example, the coating layer 22 may include an alloy of lithium (Li) and silver (Ag).

In the lithium alloy represented by Li-M as set forth above, “-” may mean that the lithium element and the doping element M form an alloy with each other. In this regard, the alloy is generally classified into a solid solution and an intermetallic compound, and the lithium alloy represented by Li-M may be a solid solution.

The solid solution means that another type of solid is dissolved in one type of solid to form a monolithic solid, and atoms of different types of solids may be mixed with each other to form a single crystal structure. The solid solution may be classified into an interstitial solid solution in which atoms of another type of an element are inserted into gaps between atoms of one type of an element, and a substitutional solid solution in which at least one of atoms of one type of an element that are arranged regularly is pushed out by and replaced with an atom of another type of an element.

When atomic sizes of the lithium and the doping element M that form the alloy with each other are similar to each other, the lithium alloy may exist in the form of the substitutional solid solution. When a difference between the atomic sizes of the lithium and the doping element M is large, the lithium alloy may exist in the form of the interstitial solid solution. For example, when the coating layer 22 includes an alloy of lithium (Li) and silver (Ag), the alloy of Li—Ag may exist in the form of a substitutional solid solution.

The coating layer 22 may play a role in inducing lithium ions when the negative-electrode-free all-solid-state battery is charged. The lithium alloy represented by Li-M has high lithium ion conductivity, so that lithium ions may be uniformly precipitated in the form of a metal layer disposed between the coating layer 22 and the second negative-electrode current collector 12 when charging the all-solid-state battery. That is, the coating layer 22 may suppress uneven precipitation of lithium and the formation of dendrites, and thus the life characteristics and durability of the negative-electrode-free all-solid-state battery may be improved.

In the second embodiment, when the all-solid-state battery is initially charged at a voltage of 1.8 V to 0 V, the battery may exhibit a flat level characteristic at 0.2 V to 0.05 V in a graph in which an X-axis represents a battery capacity (mAh/cm²) and a Y-axis represents the voltage (V).

In the lithium alloy represented by Li-M included in the coating layer 22, M may be derived from a sulfide-based solid electrolyte represented by a following Chemical formula 1:

Li_{a-b}M_{b}P_{c}S_{d}Xₑ [Chemical formula 1]

(The M includes at least one selected from the group consisting of Ag, Na, K, Rb, Cs, Fr, and combinations thereof, and the X includes at least one selected from the group consisting of F, Cl, Br, I, and combinations thereof, wherein 0<a≤15, 0.02≤b≤0.9, 0≤c≤3, 0<d≤12, 0≤e≤3.)

Before the initial charging, the all-solid-state battery may include an interfacial layer (not shown) including the sulfide-based solid electrolyte represented by the Chemical Formula 1 and disposed on the second negative-electrode current collector 12. The interfacial layer may be converted into the coating layer 22 including the lithium alloy represented by Li-M during the charging/discharging process.

Specifically, when the all-solid-state battery according to the second embodiment is charged, the doping element M of the sulfide-based solid electrolyte represented by the Chemical Formula 1 migrates along a lithium ion migration path in the sulfide-based solid electrolyte in a form of M⁺ and escapes to an outside from a particle interface of the sulfide-based solid electrolyte. The M⁺ that has escaped to the outside is reduced to the metal M. Alternatively, when the sulfide-based solid electrolyte is decomposed at a low voltage, the metal M may be produced as a decomposition product.

The metal M reacts with lithium ions (L⁺) that have migrated from the positive-electrode active material layer 42 to the interfacial layer through the solid electrolyte layer 32 to form a lithium alloy represented by Li-M. That is, during the initial charging of the all-solid-state battery, the interfacial layer is converted into the coating layer 22 including the lithium alloy and LiₐP_{c}S_{d}Xₑ (X, a, c, d, and e are the same as defined above in the Chemical Formula 1). The LiₐP_{c}S_{d}Xₑ may be a compound in which the doping element M has been removed from the sulfide-based solid electrolyte represented by the Chemical Formula 1. When the charging process progresses further and a significant portion of the metal M constitutes the lithium alloy, the lithium ions are precipitated in the form of lithium metal in pores present in the coating layer 22. As a result, the coating layer 22 may include the lithium alloy represented by Li-M, LiₐP_{c}S_{d}Xₑ, and the lithium metal produced via the precipitation of lithium ions.

The number of the pores in the coating layer 22 is not great. Thus, when the charging is in progress, the lithium ions released from the positive-electrode active material layer 42 are stored in a form of the lithium metal layer 60 disposed between the coating layer 22 and the negative-electrode current collector 12, as shown in FIG. 3.

When the negative-electrode-free all-solid-state battery according to the second embodiment is discharged, the lithium metal layer 60 is ionized and returns to the positive-electrode active material layer 42. At this time, the coating layer 22 remains without returning to the interfacial layer including the sulfide-based solid electrolyte represented by the Chemical Formula 1. That is, the coating layer 22 of the negative-electrode-free all-solid-state battery according to the second embodiment of the present disclosure may include the lithium alloy represented by Li-M and LiₐP_{c}S_{d}Xₑ in the discharged state of the battery.

The sulfide-based solid electrolyte may have an argyrodite type crystal structure. The argyrodite type crystal structure has the same structure as that of the ore Ag₈GeS₆ and exhibits high lithium ion conductivity, and may be represented by Li_{7-b}M_{b}PS₅X, Li_{5-b}M_{b}PS₄X₂, Li_{6-b}M_{b}PS₅X, Li_{7-b}M_{b}P₂S₈X, Li_{4-b}M_{b}PS₄X, etc. In the sulfide-based solid electrolyte represented by the above Chemical Formula 1, a Li-site of the sulfide-based solid electrolyte as the base may be substitutionally doped with the element M.

As a value of b increases in the above sulfide-based solid electrolyte, the peak appearing at 2θ=29.8°±1.0° of the XRD result may shift to a smaller angle. In the XRD analysis of the above sulfide-based solid electrolyte, the shift of the peak to the smaller angle means that the distance between lattice planes or the interplanar spacing (d) has increased, which may be due to the substitutional doping of the element M having a larger ionic radius than that of the lithium ion into the Li-site of the sulfide-based solid electrolyte.

A method for producing the sulfide-based solid electrolyte represented by the above Chemical formula 1 is not particularly limited, and may include, for example, a step of preparing a raw material, a step of pulverizing the raw material to obtain an intermediate material, and a step of heat-treating the intermediate material.

The raw material may include a precursor compound commonly used in preparing the sulfide-based solid electrolyte. The compound precursor may include a precursor compound generally used to prepare the sulfide-based solid electrolyte, and may include, for example, Li₂S, P₂S₅, LiX, simple substance lithium, simple substance sulfur, simple substance phosphorus, etc. In this regard, the “simple substance” may mean a simple substance that is composed of a single element and exhibits unique chemical properties.

The raw material may further include a doping precursor which may include a compound precursor including the element M to be substitutionally doped into the sulfide-based solid electrolyte. For example, the doping precursor may include MX (wherein M includes at least one selected from the group consisting of Ag, Na, K, Rb, Cs, Fr, and combinations thereof, and X includes at least one selected from the group consisting of F, Cl, Br, I, and combinations thereof). The MX may include, for example, AgF, AgCl, AgBr, and AgI.

The prepared compounds may be weighed and mixed with each other based on a target composition of the sulfide-based solid electrolyte to obtain a mixture, and the mixture may be subjected to grinding at 400 rpm to 1,000 rpm to obtain an intermediate material.

A grinding time for which the mixture is subjected to the grinding is not particularly limited, and may be, for example, in a range of 1 hour to 36 hours.

Thereafter, the intermediate material may be heat-treated at 400° C. to 600° C. for 25 minutes to 36 hours to obtain a crystalline sulfide-based solid electrolyte. When the temperature and the time of the heat treatment are below the above numerical ranges, the crystallinity of the sulfide-based solid electrolyte may not be sufficient, and thus the lithium ion conductivity may decrease. When the temperature and the time of the heat treatment exceed the above numerical ranges, the solid electrolyte may deteriorate.

The all-solid-state battery of the second embodiment may be manufactured by a step of coating the sulfide-based solid electrolyte represented by the Chemical Formula 1 on the second negative-electrode current collector 12 to form the interfacial layer thereon, a step of stacking the second solid electrolyte layer 32, the second positive-electrode active material layer 42, and the second positive-electrode current collector 52 on the interfacial layer to obtain an intermediate stack, and a step of charging and discharging the intermediate stack under application of the charging and discharging voltages thereto to convert the interfacial layer into the coating layer 22 including the lithium alloy represented by Li-M (wherein M includes at least one selected from the group consisting of Ag, Na, K, Rb, Cs, Fr, and combinations thereof).

A coating scheme of coating the interfacial layer is not particularly limited, and may employ any scheme that is widely used in the technical field to which the present disclosure belongs.

When a voltage is applied to the intermediate stack which thus is charged, the sulfide-based solid electrolyte may be decomposed at a predetermined voltage, such that the interfacial layer may be converted into the coating layer 22. During the decomposition process of the sulfide-based solid electrolyte, the doping element M may form the alloy together with lithium to form the lithium alloy represented by Li-M. Furthermore, the remaining elements Li, S, P, or X included in the sulfide-based solid electrolyte may form Li₂S, Li₃P, and LiX.

Accordingly, the coating layer 22 may include the lithium alloy represented by Li-M and may further include at least one of Li₂S, Li₃P, and LiX.

In one embodiment, the step of converting the interfacial layer into the coating layer 22 including the lithium alloy represented by Li-M may be irreversible. That is, at least a portion of the lithium alloy may not be converted back into the sulfide-based solid electrolyte during the discharging process of the negative-electrode-free all-solid-state battery.

In one example, at least one of Li₂S, Li₃P, and LiX produced during the charging process of the all-solid-state battery may be converted back into a form of the sulfide-based solid electrolyte during the discharging process. That is, Li₂S, Li₃P, and LiX produced during the charging process may be produced reversibly.

Accordingly, after the charging and discharging process of the all-solid-state battery, the coating layer 22 may include a compound in which the content of the doping element M in the sulfide-based solid electrolyte included in the interfacial layer is reduced.

In one embodiment, the interfacial layer may be converted into the coating layer 22 including a lithium alloy represented by Li-M under application of a charge/discharge voltage of 0.7 V to 0.9 V. Specifically, the interfacial layer may be converted into the coating layer 22 under the application of the charge/discharge voltage of 1.6 V.

In one embodiment, in the step of charging and discharging the intermediate stack to convert the interfacial layer into the coating layer 22, the white interfacial layer may be converted into the black coating layer 22.

Specifically, the interfacial layer includes the sulfide-based solid electrolyte. Since the sulfide-based solid electrolyte exhibits white color, the interfacial layer may be white.

The coating layer 22 may include the metal M or the lithium alloy represented by Li-M, and may further include at least one of Li₂S, Li₃P, and LiX. In this regard, the Li-M exhibits the black color, and Li₂S, Li₃P, and LiX exhibit the white color. Thus, a content of the metal M or the lithium alloy represented by Li-M increases, a color of the coating layer 22 may change to black.

Accordingly, the intermediates stack including the interfacial layer is charged and discharged such that the stack is converted to the coating layer 22 and then, the color of the coating layer 22 is observed with the naked eye and the observed color is the black. This may mean that the coating layer 22 includes the lithium alloy represented by Li-M.

In this regard, a whiteness index of the white interfacial layer may be 70 or higher, and the whiteness index of the black coating layer 22 may be 30 or lower.

As used herein, the whiteness index refers to the international standard CIE whiteness index, and “CIE whiteness index” refers to the whiteness index as measured using the AATCC (American Association of Textile Chemists and Colorists) test method 110-1994 and calculated using the formula set forth in the test method based on the light source D65 and the observer angle of 1976 10°. The CIE whiteness index is represented by a numerical value from 0 to 100, and the higher the value, the greater the whiteness. However, the whiteness index of the light-emitting body may exceed 100.

The sulfide-based solid electrolyte included in the interfacial layer is white. Thus, when the whiteness index of the interfacial layer is lower than 70, this may mean that impurities other than the sulfide-based solid electrolyte are contained therein. The lithium alloy included in the coating layer 22 is black. Thus, when the whiteness index of the coating layer 22 exceeds 30, this may mean that the lithium alloy is not completely formed.

Hereinafter, the present disclosure will be described in detail with reference to following Present Examples and Comparative Examples. However, the technical idea of the present disclosure is not limited or restricted thereto.

### Present Example 1. Li₆PS₅Cl+Ag 0.1

Lithium sulfide (Li₂S) powders (purchased from Sigma Aldrich), phosphorus pentasulfide (P₂S₅) powders (purchased from Sigma Aldrich), lithium chloride (LiCl) powders, and silver chloride (AgCl) powders as raw materials for the sulfide-based solid electrolyte were weighed and prepared according to the composition of Li_{5.9}Ag_{0.1}PS₅Cl.

The prepared raw materials were placed into a stirrer and mixed with each other at a speed of about 450 rpm for about 2 hours, and then the mixture was heat-treated at a temperature of about 550° C. in a vacuum atmosphere to obtain the sulfide-based solid electrolyte.

### Present Example 2. Li₆PS₅Cl+Ag 0.3

A sulfide-based solid electrolyte was obtained through the same process as in Present Example 1, except that the raw materials for the sulfide-based solid electrolyte were weighed and prepared according to the composition of Li_{5.7}Ag_{0.3}PS₅Cl.

### Present Example 3. Li₆PS₅Cl+Ag 0.4

A sulfide-based solid electrolyte was obtained through the same process as in Present Example 1, except that the raw materials for the sulfide-based solid electrolyte were weighed and prepared according to the composition of Li_{5.6}Ag_{0.4}PS₅Cl.

### Present Example 4. Li₆PS₅Cl+Ag 0.5

A sulfide-based solid electrolyte was obtained through the same process as in Present Example 1, except that the raw materials for the sulfide-based solid electrolyte were weighed and prepared according to the composition of Li_{5.5}Ag_{0.5}PS₅Cl.

### Present Example 5. Li₆PS₅Cl+Ag 0.6

A sulfide-based solid electrolyte was obtained through the same process as in Present Example 1, except that the raw materials for the sulfide-based solid electrolyte were weighed and prepared according to the composition of Li_{5.4}Ag_{0.6}PS₅Cl.

### Present Example 6. Li₆PS₅Cl+Ag 0.02

A sulfide-based solid electrolyte was obtained through the same process as in Present Example 1, except that the raw materials for the sulfide-based solid electrolyte were weighed and prepared according to the composition of Li_{5.98}Ag_{0.02}PS₅Cl.

### Present Example 7. Li₆PS₅Cl+Ag 0.06

A sulfide-based solid electrolyte was obtained through the same process as in Present Example 1, except that the raw materials for the sulfide-based solid electrolyte were weighed and prepared according to the composition of Li_{5.94}Ag_{0.06}PS₅Cl.

### Present Example 8. Li₃PS₄+Ag 0.1

Lithium sulfide (Li₂S) powders (purchased from Sigma Aldrich), phosphorus pentasulfide (P₂S₅) powders (purchased from Sigma Aldrich), and silver sulfide (Ag₂S) powders as raw materials for the sulfide-based solid electrolyte were weighed and prepared according to the composition of Li_{2.9}Ag_{0.1}PS₄.

The prepared raw materials were placed into a stirrer and mixed with each other at a speed of about 450 rpm for about 2 hours, and then the mixture was heat-treated at a temperature of about 200° C. in a vacuum atmosphere to obtain the sulfide-based solid electrolyte.

### Comparative Example 1. Li₆PS₅Cl

A sulfide-based solid electrolyte was obtained through the same process as in Present Example 1, except that the silver chloride (AgCl) powders were not added during the process of preparing the raw materials. The composition of the sulfide-based solid electrolyte according to Comparative Example 1 was identified as Li₆PS₅Cl.

### Comparative Example 2. Li₃PS₄

A sulfide-based solid electrolyte was obtained through the same process as in Present Example 8, except that the silver sulfide (Ag₂S) powders were not added during the process of preparing the raw materials. The composition of the sulfide-based solid electrolyte according to Comparative Example 2 was identified as Li₃PS₄.

### Experimental Example 1: SEM and EDS Analysis

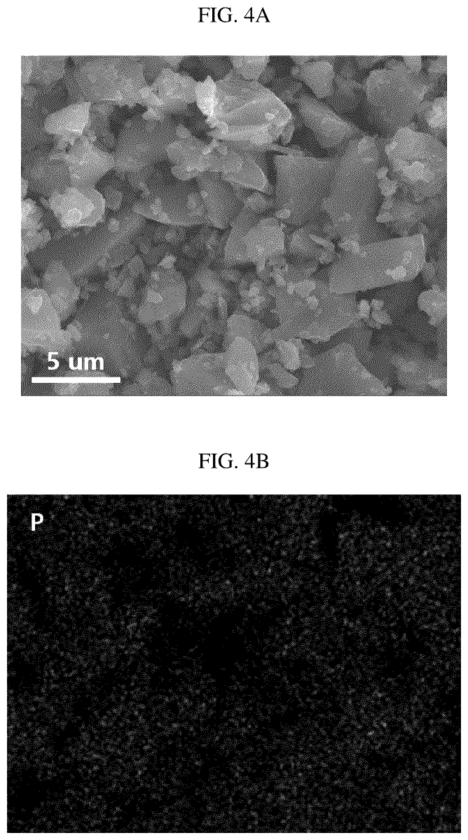

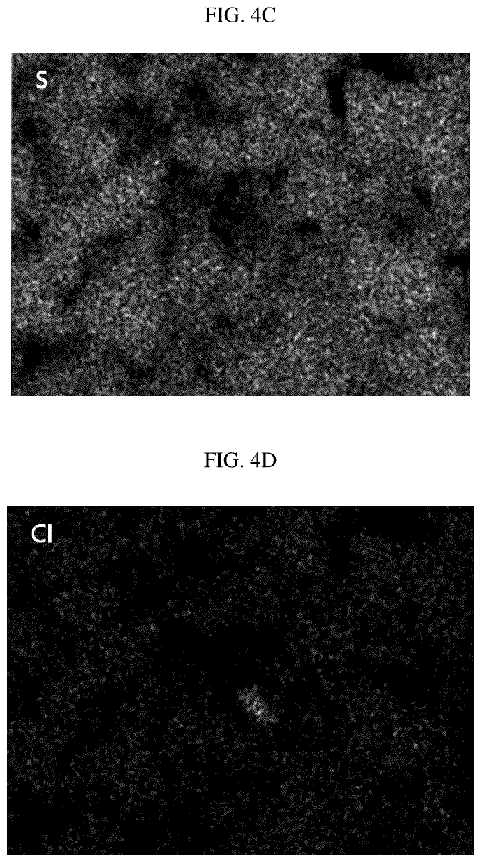

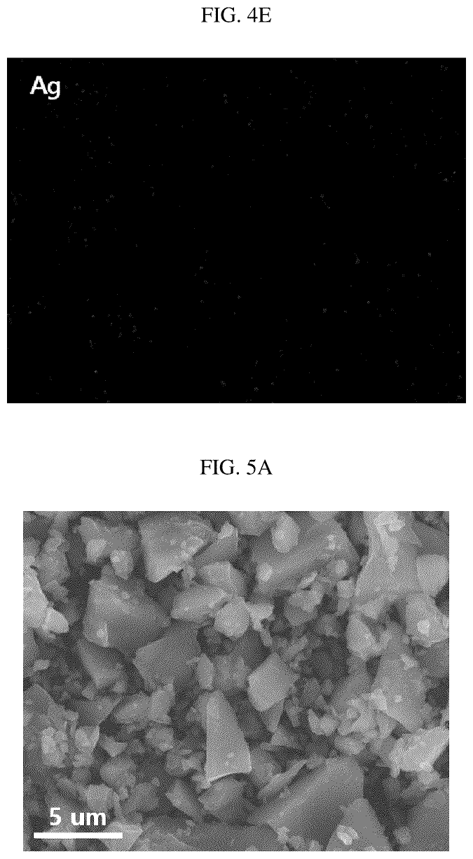

In order to visually identify the types of elements included in the sulfide-based solid electrolyte synthesized according to Present Example 1, the sulfide-based solid electrolyte according to Present Example 1 was photographed using a scanning electron microscope (SEM) and an energy dispersive spectrometer (EDS), and then the photographed images are depicted in FIGS. 4A to 4E, respectively.

According to FIG. 4A, it may be identified that a powder-type sulfide-based solid electrolyte is synthesized. Furthermore, with referring to FIGS. 4B to 4E, it may be identified that the doping element Ag is correctly doped into the sulfide-based solid electrolyte based on the fact that the sulfide-based solid electrolyte includes P, S, Cl, and Ag.

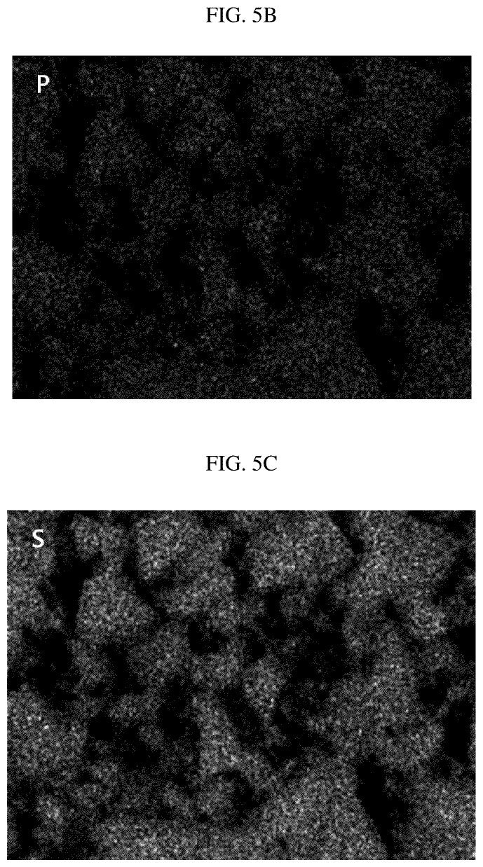

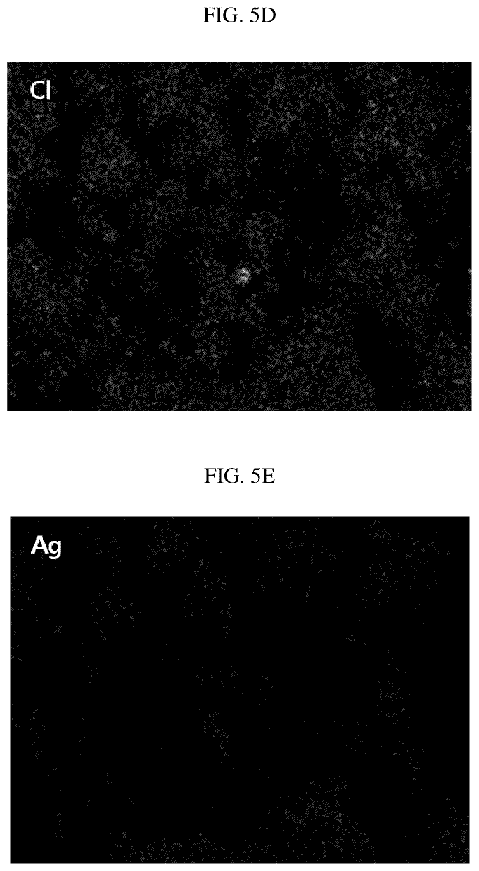

In order to visually identify the types of elements included in the sulfide-based solid electrolyte synthesized according to Present Example 2, the sulfide-based solid electrolyte according to Present Example 2 was photographed using a scanning electron microscope (SEM) and an energy dispersive spectrometer (EDS), and then the photographed images are shown in FIGS. 5A to 5E, respectively.

According to FIG. 5A, it may be identified that a powder-type sulfide-based solid electrolyte is synthesized. Furthermore, with referring to FIGS. 5B to 5E, it may be identified that the sulfide-based solid electrolyte is correctly doped with the doping element Ag based on the fact that P, S, Cl, and Ag are included in the sulfide-based solid electrolyte.

### Experimental Example 2: XRD Peak Analysis

In order to identify the composition of the sulfide-based solid electrolyte synthesized according to each of Present Examples and Comparative Examples, XRD analysis was performed thereon. A reference peak was set to a peak of Si.

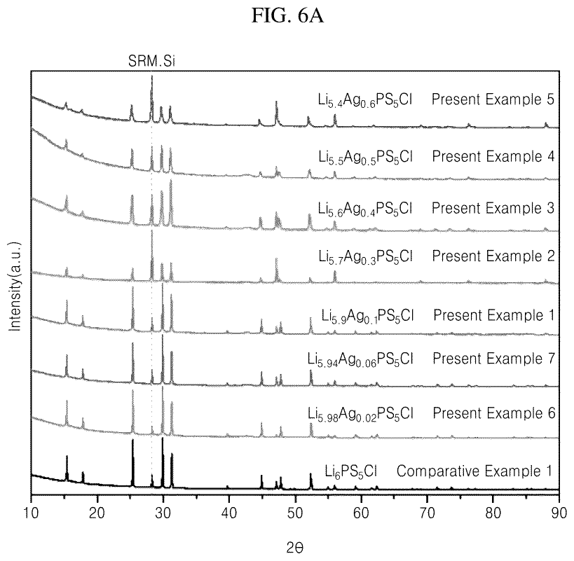

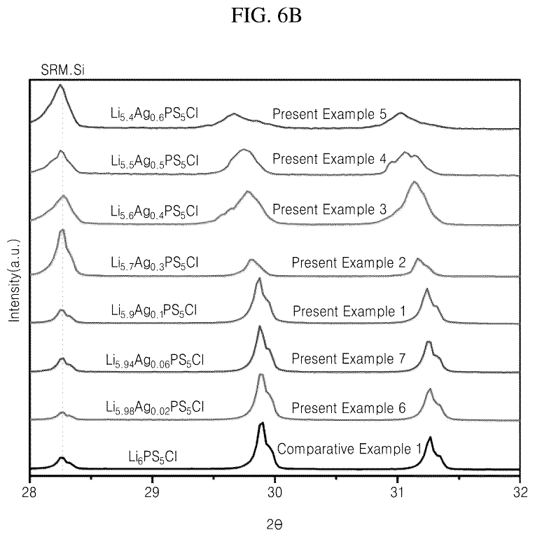

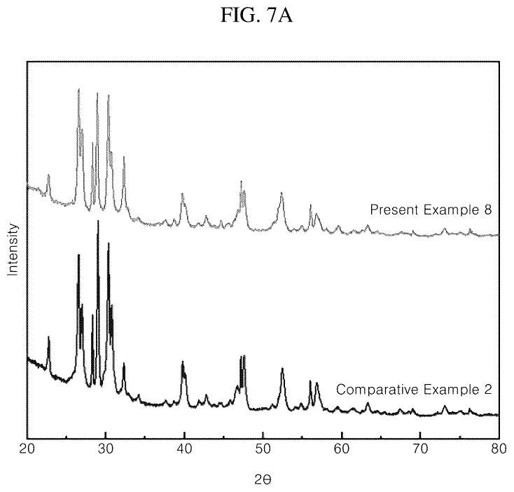

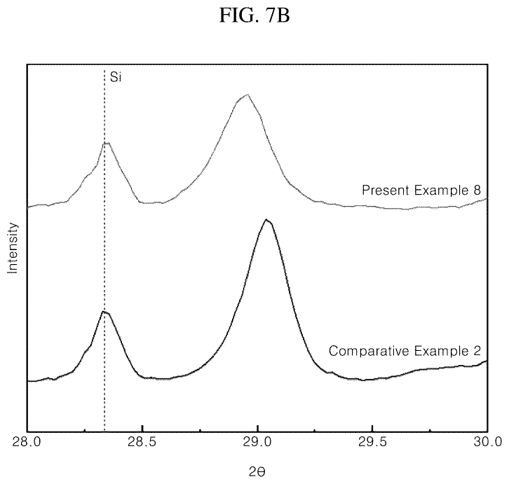

The results on Present Example 1 to Present Example 7 and Comparative Example 1 are shown in FIG. 6A. FIG. 6B is an enlarged image of a region around 2θ=30° of FIG. 6A. Furthermore, the results on Present Example 8 and Comparative Example 2 are shown in FIG. 7A. FIG. 7B is an enlarged image of a region around 2θ=29° of FIG. 7A.

Referring to FIG. 6A, based on a comparing result of the peaks of Comparative Example 1 and Present Example 1 to Present Example 7, it may be identified that no new Ag peak is observed despite the addition of Ag. In particular, according to FIG. 6B, it may be identified that Ag is substitutionally doped into the Li-site due to the fact that the Li peak observed at around 30° shifts to the left side as a content of AgCl increases. The fact that the Li peak shifted to the left side is predicted to be due to the increase in the interstitial distance (d) as Ag which has a larger ionic radius than that of the lithium ion is substitutionally doped into the Li-site.

Referring to FIG. 7A, based on a comparing result of the peaks of Comparative Example 2 and Present Example 8, it may be identified that no new Ag peak is observed despite the addition of Ag. In particular, according to FIG. 7B, the Li peak observed at around 29° in Comparative Example 2 shifts to the left side in Present Example 8 containing AgCl, thus indicating that Ag is substitutionally doped into the Li-site. The fact that the Li peak shifted to the left side is predicted to be due to the increase in the interstitial distance (d) as Ag which has a larger ionic radius than that of the lithium ion is substitutionally doped into the Li-site.

Thus, it was identified that regardless of the specific composition of the synthesized sulfide-based solid electrolyte, the XRD peak shifted to a smaller angle when the doping element was substitutionally doped into the Li-site of the sulfide-based solid electrolyte. In particular, it was observed that the higher the content of the doped Ag, the greater a shift amount.

### Manufacturing Example

A half-cell was manufactured using the sulfide-based solid electrolyte according to Present Example 4.

Specifically, the sulfide-based solid electrolyte prepared according to Present Example 4 and a rubber (Butadiene rubber: BR) as the binder were added to butyl butyrate (BB) as a solvent to prepare a slurry. The slurry was applied to a negative-electrode current collector made of stainless steel and dried to form the interfacial layer.

Lithium sulfide (Li₂S) powders (purchased from Sigma Aldrich), phosphorus pentasulfide (P₂S₅) powders (purchased from Sigma Aldrich), lithium chloride (LiCl) powders, and silver chloride (AgCl) powders as raw materials for the sulfide-based solid electrolyte were mixed with each other to prepare a raw material. The raw material was subjected to a ball milling process for uniform mixing to prepare the precursor powders for the solid electrolyte precursor. The precursor powders for the solid electrolyte precursor were heat-treated at about 550° C. for about 5 hours to obtain a sulfide-based solid electrolyte represented by Li₆PS₅Cl and having an argyrodite type crystal structure including Cl.

The interfacial layer was pressed against one surface of the solid electrolyte layer including the sulfide-based solid electrolyte. Thereafter, a lithium foil (purchased from Honjo) was attached to the other surface of the solid electrolyte layer to manufacture a half-cell.

### Experimental Example 3: Evaluation of Electrochemical Characteristics

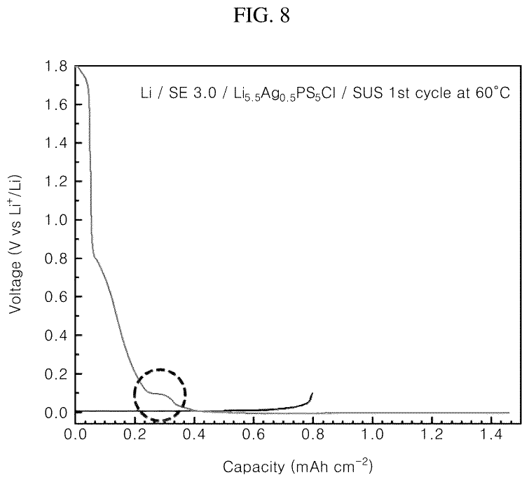

FIG. 8 shows the voltage-capacity graph when the half-cell according to the manufacturing example was initially charged and discharged at 60° C.

Referring to FIG. 8, when the half-cell was charged while decreasing the charge/discharge voltage from 1.8 V, change in a slope was observed at the charge/discharge voltage of 0.8 V. The change in the slope may mean that the sulfide-based solid electrolyte included in the interfacial layer of the half-cell is decomposed and converted into the coating layer.

In addition, according to FIG. 8, it may be identified that a flat level characteristic is exhibited in the voltage range of 0.05 V to 0.2 V. The flat level characteristic is observed due to the fact that silver (Ag) ions produced in the sulfide-based solid electrolyte react with the lithium ions to form the Li—Ag alloy.

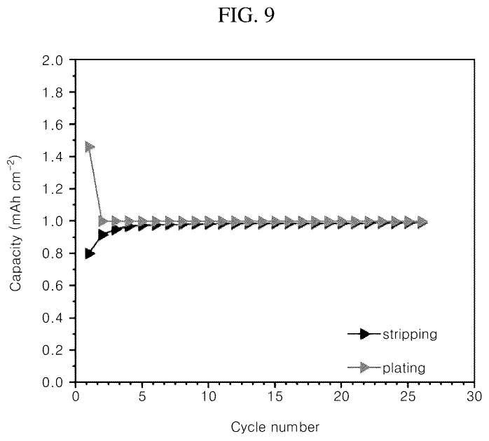

FIG. 9 shows the results of measuring the capacity of the half-cell according to the manufacturing example while increasing the charge/discharge cycle of the half-cell according to the manufacturing example.

According to FIG. 9, it may be identified that when lithium metal is plated on the negative-electrode current collector and thus the cell was charged, the cell capacity decreases at the initial cycle, and then the cell capacity is maintained until the 26th cycle of the test. Through this fact, it is identified that the cell capacity decreases at the initial charge/discharge cycle when Ag is released from the sulfide-based solid electrolyte to form the Li—Ag alloy, and that excellent capacity retention rate is observed from a timing after the initial cycle when the lithium alloy is sufficiently formed.

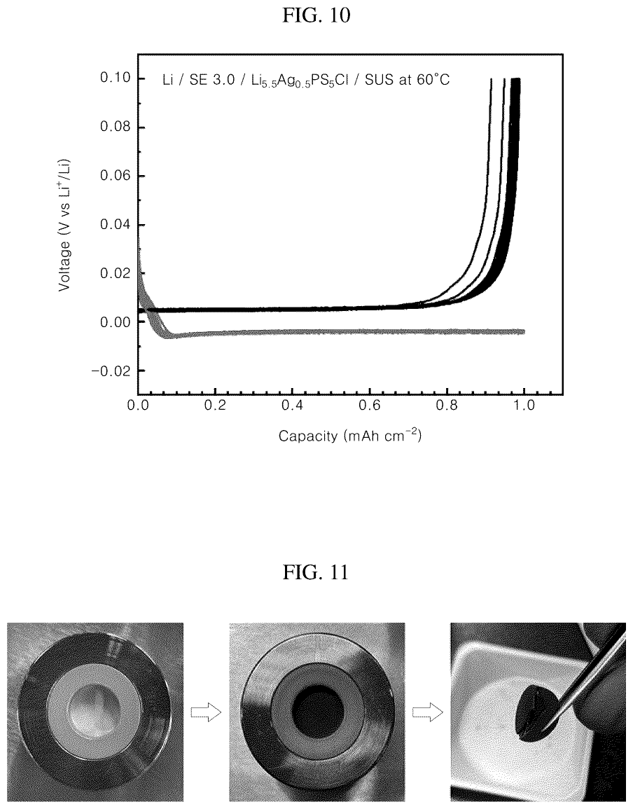

FIG. 10 shows a voltage-capacity graph of the half-cell. Based on the fact that the shape of the graph is maintained in a constant manner, it may be identified that the charge/discharge of the half-cell is stably performed.

### Experimental Example 4: Whiteness Index Evaluation

FIG. 11 shows the states of the half-cell according to the manufacturing example before and after the initial charging thereof. Referring to FIG. 11, it may be identified with the naked eye that before the initial charging of the half-cell, the lithium alloy represented by Li—Ag is not formed, so that the white interfacial layer is observed. However, it may be identified with the naked eye that after the initial charging, Ag released from the sulfide-based solid electrolyte and the lithium alloy represented by Li—Ag are formed, so that the black coating layer is observed.

The Experimental Examples and Present examples of the present disclosure have been described in detail above. The scope of the present disclosure is not limited to the experimental examples and examples as described above, and various modifications and improvements made by those skilled in the art using the basic concept of the present disclosure defined in the following patent claim scope are also included in the scope of the present disclosure.

What is claimed is:

1. A sulfide-based solid electrolyte comprising a compound represented by a following Chemical formula 1:
Li_{a-b}M_{b}P_{c}S_{d}Xₑ [Chemical formula 1]
wherein M includes at least one selected from the group consisting of Ag, Na, K, Rb, Cs, Fr, and a combination thereof,
wherein X includes at least one selected from the group consisting of F, Cl, Br, I, and combinations thereof,
wherein 0<a≤15, 0.02≤b≤0.9, 0≤c≤3, 0<d≤12, and 0≤e≤3.

2. The sulfide-based solid electrolyte of claim 1, wherein M is Ag.

3. The sulfide-based solid electrolyte of claim 1, wherein the sulfide-based solid electrolyte has an argyrodite type crystal structure.

4. The sulfide-based solid electrolyte of claim 1, wherein a peak appearing at 2θ=29.8°±1.0° of an XRD result of the sulfide-based solid electrolyte shifts to a smaller angle as b increases.

5. An all-solid-state battery comprising:
a negative-electrode current collector;
a negative-electrode active material layer disposed on the negative-electrode current collector;
a solid electrolyte layer disposed on the negative-electrode active material layer;
a positive-electrode active material layer disposed on the solid electrolyte layer; and
a positive-electrode current collector disposed on the positive-electrode active material layer,
wherein at least one of the negative-electrode active material layer, the positive-electrode active material layer, and the solid electrolyte layer includes the sulfide-based solid electrolyte of claim 1.

6. The all-solid-state battery of claim 5, wherein when the all-solid-state battery is initially charged under application of a voltage of 1.8 V to 0 V thereto, the battery exhibits a flat level characteristic at 0.2 V to 0.05 V in a graph in which an X-axis represents a battery capacity (mAh/cm²) and a Y-axis represents the voltage (V).

7. An all-solid-state battery comprising:
a negative-electrode current collector;
a coating layer disposed on the negative-electrode current collector;
a solid electrolyte layer disposed on the coating layer;
a positive-electrode active material layer disposed on the solid electrolyte layer; and
a positive-electrode current collector disposed on the positive-electrode active material layer,
wherein the coating layer comprises a lithium alloy represented by Li-M, wherein M includes at least one selected from the group consisting of Ag, Na, K, Rb, Cs, Fr, and combinations thereof,
wherein M in the lithium alloy is derived from the sulfide-based solid electrolyte of claim 1.

8. The all-solid-state battery of claim 7, wherein when the all-solid-state battery is initially charged under application of a voltage of 1.8 V to 0 V thereto, the battery exhibits a flat level characteristic at 0.2 V to 0.05 V in a graph in which an X-axis represents a battery capacity (mAh/cm²) and a Y-axis represents the voltage (V).

9. A method for preparing a sulfide-based solid electrolyte, the method comprising:
preparing a raw material;
pulverizing the raw material to obtain an intermediate material; and
heat-treating the intermediate material,
wherein the sulfide-based solid electrolyte comprises a compound represented by a following Chemical formula 1:
Li_{a-b}M_{b}P_{c}S_{d}Xₑ [Chemical formula 1]
wherein M includes at least one selected from the group consisting of Ag, Na, K, Rb, Cs, Fr, and a combination thereof,
wherein X includes at least one selected from the group consisting of F, Cl, Br, I, and combinations thereof,
wherein 0<a≤15, 0.02≤b≤0.9, 0≤c≤3, 0<d≤12, and 0≤e≤3.

10. The method of claim 9, wherein M is Ag.

11. The method of claim 9, wherein the sulfide-based solid electrolyte has an argyrodite type crystal structure.

12. The method of claim 9, wherein a peak appearing at 2θ=29.8°±1.0° of an XRD result of the sulfide-based solid electrolyte shifts to a smaller angle as b increases.
